(19) United States
(12) Patent Application Publication
(10) Pub. No.: US 2010/0088740 A1
(43) Pub. Date: Apr. 8, 2010

(54) Methods for performing secure on-line testing without pre-installation of a secure browser

(75) Inventor: A. Bryan Waters, Monterey, CA (US)

Correspondence Address: MAURICE M KLEE, 1951 BURR STREET, FAIRFIELD, CT, 06824, US

(73) Assignee: Bookette Software Company, Monterey, CA (US)

(21) Appl. No.: 12/287,336

(22) Filed: Oct. 8, 2008

(51) Int. Cl. G06F 17/00; H04L 9/00

(52) U.S. Cl. 726/1

(57) ABSTRACT

Methods for performing secure on-line testing without the need for pre-installation of a secure browser are provided. The methods use a general purpose web browser which is already installed on the user's computer and extend the browser so as to restrict the functionality of the user's computer in at least one way which makes the computer more secure with regard to testing. The extending occurs through the transmission of trusted code to the user's computer over the internet. The elimination of the need for pre-installation represents a major savings to school districts in terms of the amount of IT professional time that must be dedicated to on-line testing, especially for school districts having large numbers of installed computers. Apparatus for practicing the methods is also provided.

### FIELD

This invention relates to testing (also referred to herein as “assessment”) performed over the internet. Such testing is referred to in the art as “on-line testing,” “on-line assessment,” “web-based testing,” “web-based assessment,” and similar terms (referred to herein collectively as “on-line testing”). In particular, the invention relates to secure on-line testing where the user's ability to use unauthorized materials during a test is reduced. In certain embodiments, the invention also relates to on-line instruction (see discussion below under the heading Conclusion).

As discussed and illustrated below, the invention provides methods for performing secure on-line testing without the need for pre-installation of a secure browser, as well as apparatus for practicing the methods. The elimination of the need for pre-installation represents a major savings to school districts in terms of the amount of IT professional time that must be dedicated to on-line testing, especially for school districts having large numbers of installed computers.

### DEFINITIONS

As used herein, the following terms have the following meanings:

A “general purpose web browser” is a web browser which has a default mode which as provided by the manufacturer of the browser has a security level that does not ensure that the computer system is in a consistent state from user to user, e.g., the default mode of the browser is not a “kiosk” mode.

A “secure browser” is a browser that restricts the functionality of the computer on which it is running in at least one way.

“Secure on-line testing” means on-line testing performed on a computer whose functionality is restricted in at least one way.

“Extending” or “extended” when used in connection with a general purpose browser means adding code to the computer system on which the browser runs that: 1) interfaces with the browser's specific mechanisms for accepting trusted code and 2) changes the browser's functionality.

“Trusted code” means code that meets a trust requirement of the application code that is being extended, i.e., for the present invention, code that meets a trust requirement of a general purpose web browser, such as, INTERNET EXPLORER or FIREFOX. As understood by persons skilled in the art, a trust requirement is a requirement designed to ensure that the code is benign and/or that the code is associated with an identifiable and responsible entity. The trust requirements of INTERNET EXPLORER and FIREFOX are discussed below. It is to be understood that the term “trusted code” includes code that satisfies these requirements, as well as variations thereof which may be developed in the future, and/or the trust requirements of other general purpose web browsers now in existence or which may be developed in the future.

An “extension” includes extensions, add-ons, plug-ins, and similar technologies employed by browsers for allowing customization of browser functionality.

“Pre-installation” means an installation of software which involves assigning a directory location to the software. Pre-installation is to be distinguished from extension of a program that has already been installed on the computer and already has a directory location. In the context of a school setting, students and other non-IT personnel are not normally allowed to perform pre-installation.

A “trigger page” for the purposes of this invention is a page of a website that contains code that causes a browser extension to be activated or deactivated.

### BACKGROUND

The use of technology and computers in education has increased dramatically in recent years as local, state and federal reporting requirements have become more demanding. This is especially true in educational testing (assessment) where the results are used to make decisions regarding curriculum and funding. The importance of these assessments dictates that the results be as accurate and fair as possible.

In traditional “pencil and paper” testing, accuracy and fairness are achieved by using human proctors to ensure a controlled testing environment. In a computerized environment, the general purpose nature of the computers upon which the testing takes place makes human proctors inadequate to the task of securing and monitoring large scale assessments. The very nature of a networked computer creates an environment that provides test-takers access to tools that would normally be “left at the door” in a traditional testing environment. This includes calculators, dictionaries, spelling and grammar checkers, messaging software and other general purpose research tools. This creates a need to establish a secure environment on the computer for the test-taker that limits or controls access to tools that are inappropriate for a specific assessment.

With the broad scale movement towards computerized testing, the need to limit the amount of technical support (IT support) required to implement the testing process has become ever more pressing. Solutions that require up front preparation, including, but not limited to the installation of software to administer tests, cause implementation issues for the over-burdened IT departments of educational institutions. Many public school districts have a single network administrator to address computer issues for all the schools in the district. This has caused a preference for assessment tools that do not require pre-installation of software packages. Indeed, the resource constraint has become such a problem for schools that states and districts are requiring on-line testing in their RFPs (Request For Proposals), all but forcing vendors to provide tests that are delivered using web browsers.

Since the delivery of assessments using a general-purpose web-browser has become a practical requirement to address the limited IT resources in schools and since security is a non-optional requirement to ensure the accuracy and fairness of the data, vendors are placed in the difficult situation of having to provide solutions that address both conflicting needs. Different vendors have attempted to address this solution with various approaches but all current solutions have required some amount of pre-installation.

For example, Questionmark Computing Ltd. offers a product under the name QUESTIONMARK SECURE which is available on-line from the company but requires the user to run an install program which asks the user to (1) accept a license agreement and (2) either accept a default location for installation of the software (i.e., c:\Program Files\Questionmark) or to select an alternative directory by clicking a “Browse” button which allows the user to browse the local drive and directories. Plainly, pre-installation of this product requires intervention of an IT professional and cannot and should not be performed by students. See also Questionmark's U.S. Patent Publication No. 2004/0230825 entitled “Secure Browser.”

Vantage Learning has a similar secure browser sold under the name VANGUARD which also requires pre-installation by an IT professional. Indeed, for a state wide installation, a lead time for the pre-installation of such a secure browser can be on the order of several months. Software Secure, Inc. has also addressed the problem of providing secure on-line testing. Like Questionmark and Vantage Learning, Software Secure's product (SECUREXAM BROWSER) requires pre-installation by an IT professional. Indeed, its system requirements include 100 MB of free hard drive space on each computer on which it is installed.

The problem with pre-installation is that in a school setting, computers which students are allowed to access are normally configured so that the student cannot install software. This ban on software installation also normally extends to teachers and other non-IT personnel. The reason for the ban on software installation by students and others is that installation of a new software program runs the risk that a computer can become inoperable due to incompatibility with existing software and/or an incompatible installation process. Allowing students to install any of the myriad software programs available on the internet will quickly disable numerous computers in a school district, creating a nightmare for IT personnel. And, of course, once a computer is disabled, e.g., in a computer laboratory, it remains disabled until it is brought back on line, thus depriving students assigned to the computer, but not involved with the disablement, from using the computer until it is repaired. Indeed, the problem with students altering the function of school computers is so severe that even with a ban on installation, many school districts reset their computers every night to a standard configuration, a procedure known as “mirroring.”

A further problem with pre-installation involves updating and correction of bugs in the software once installed. In many cases, such activities involve reinstalling the software which puts further strains on the limited IT resources of school districts.

Thus, when faced with installing a secure browser of the type offered by Questionmark, Vantage Learning, and Software Secure, as well as in maintaining these products, school districts must expend substantial amounts of their IT budgets. Although this deficiency in the existing products has been long recognized in the field, until the present invention, there was no known solution to the problem.

### SUMMARY

In accordance with one of its aspects, the invention provides a method for administering a test and/or providing instruction over the internet to a user (e.g., a student) whose installed computer programs comprise a general purpose web browser, said method comprising:
(a) providing a server which is capable of:
   (i) transmitting trusted code over the internet to the user's computer; and
   (ii) activating said trusted code on said user's computer;
      said trusted code extending the user's general purpose web browser so as to restrict the functionality of the user's computer in at least one way (e.g., in a way which makes the computer more secure with regard to the testing and/or more focused on providing the instruction);
(b) enabling said trusted code on the user's computer from the server; and
(c) providing the test and/or the instruction to the user on the user's computer from the server while the functionality of the user's computer is restricted in said at least one way;
   where the enabling of step (b) comprises either transmitting and activating the trusted code on the user's computer in cases where the trusted code is not pre-cached on the user's computer or activating the trusted code in cases where the trusted code is pre-cached on the user's computer.

In accordance with another aspect, the invention provides a method for administering a test and/or providing instruction over the internet to a user whose installed computer programs comprise a general purpose web browser, said method comprising:
(a) providing a website which is capable of:
   (i) transmitting trusted code over the internet to the user's computer; and
   (ii) activating said trusted code on said user's computer;
      said trusted code extending the user's general purpose web browser so as to restrict the functionality of the user's computer in at least one way;
(b) enabling said trusted code on the user's computer from the website; and
(c) providing the test and/or the instruction to the user on the user's computer from the website while the functionality of the user's computer is restricted in said at least one way;
   where the enabling of step (b) comprises either transmitting and activating the trusted code on the user's computer in cases where the trusted code is not pre-cached on the user's computer or activating the trusted code in cases where the trusted code is pre-cached on the user's computer.

In accordance with a further aspect, the invention provides a method for taking a test and/or receiving instruction over the internet comprising:
(a) visiting a website using a computer whose installed computer programs comprise a general purpose web browser;
(b) receiving trusted code from the website over the internet, said trusted code extending the general purpose web browser so as to restrict the functionality of the computer in at least one way;
(c) activating the trusted code; and
(d) receiving the test and/or the instruction over the internet from a website while the trusted code is activated.

In accordance with an additional aspect, the invention provides a method for taking a test and/or receiving instruction over the internet using a computer which has (i) a general purpose web browser and (ii) trusted code that extends the general purpose web browser so as to restrict the functionality of the computer in at least one way, said method comprising:
(a) visiting a website that activates the trusted code; and
(b) receiving the test and/or the instruction over the internet from a website while the trusted code is activated.

In accordance with further aspects, the invention provides a computer program embodied in a tangible computer readable medium (e.g., a hard disk, flash drive, CD-ROM, or the like) for performing the above method aspects of the invention. In accordance with additional aspects, the invention provides a computer system (e.g., CPU, internet connection, storage media, printer, display, keyboard, mouse, etc.) for the execution of the method aspects of the invention.

In accordance with another aspect, the invention provides a system comprising:
(a) a processor;
(b) an internet connection coupled to the processor; and
(c) a memory unit coupled to the processor, said memory unit storing a computer program for transforming a user's general purpose web browser into a secure browser, said computer program including programming instructions for performing the following steps:
(i) transmitting trusted code through the internet connection to a user's computer; and
(ii) activating said trusted code on the user's computer;
   wherein the trusted code extends a general purpose web browser on the user's computer so as to restrict the functionality of the user's computer in at least one way.

Additional aspects, features, and advantages of the invention are set forth in the detailed description which follows, and in part will be readily apparent to those skilled in the art from that description or recognized by practicing the invention as described herein. The accompanying drawings are included to provide a further understanding of the invention, and are incorporated in and constitute a part of this specification.

It is to be understood that both the foregoing general description and the following detailed description are merely exemplary of the invention and are intended to provide an overview or framework for understanding the nature and character of the invention. It is also to be understood that the various aspects and features of the invention disclosed in this specification and in the drawings can be used in any and all combinations.

### BRIEF DESCRIPTION OF THE DRAWINGS

FIGS. 1A-1C are screen shots showing a representative series of steps which a user would take to install an ActiveX control capable of extending the user's general purpose web browser so as to make it suitable for secure on-line testing.

FIG. 2 is a flow chart illustrating a suitable sequence of steps that can take place at a website if only secure tests are to be administered.

FIG. 3 is a flow chart illustrating a suitable sequence of steps that can take place at a website if both secure and un-secure tests are to be administered.

FIGS. 4A and 4B are flow charts illustrating suitable sequences of steps for transmitting and activating trusted code for WINDOWS EXPLORER and FIREFOX, respectively.

FIG. 5 is a chart showing a directory structure suitable for use with a FIREFOX embodiment of the invention.

### DETAILED DESCRIPTION OF THE PREFERRED EMBODIMENTS

As discussed above, the present invention addresses and solves the pre-installation problem of existing secure browsers by: (1) using a general purpose web browser which is already installed on the user's computer, e.g., INTERNET EXPLORER or FIREFOX, and (2) extending the general purpose web browser so as to restrict the functionality of the user's computer in at least one way, where the extending occurs through the transmission of trusted code to the user's computer over the internet. Unlike pre-installation, such extending of a general purpose web browser using trusted code can be accomplished with minimal and, in many cases, no expenditure of IT resources. Indeed, the extending is so straightforward and simple to perform that it can be implemented by users on a regular basis, as can be needed for schools that perform mirroring to a standard configuration which does not include the trusted code. Moreover, the extending can be performed on any computer which is equipped with a general purpose web browser, i.e., the extending can be performed on essentially all commercially-available modern computers.

General Purpose Web Browsers and Trust Mechanisms/Trusted Code

General purpose web browsers, which are designed as general purpose applications, are extremely insecure from the perspective of test administration. Indeed, they generally have a default mode which as provided by the manufacturer of the browser has a security level that does not even ensure that the computer system which runs the browser is in a consistent state from user to user. By design, web browsers are built with a different security goal, namely, to give the user as much control and flexibility as possible while at the same time protecting the user from malicious software that might be present on rogue websites.

Popular web-browsers on all modern computer systems have a built-in trust-based security model (security system) whereby websites and transient code can take steps to increase their trust level and obtain a higher level of acceptability to the browser. On WINDOWS operating systems, the INTERNET EXPLORER (IE) web browser provides a technology called “ActiveX” that enables websites to transmit transient (not pre-installed) code to the user's computer for the purpose of enhancing the user's experience on the website. FIREFOX, a popular open-source web browser, provides a similar mechanism called “Extensions” and SAFARI, a web browser available on the Mac OSX operating system, uses “Plugins” for this purpose.

All of these approaches require the transient code and/or the website to meet some trust requirements before the transient code is allowed to execute on the user's computer. While the trust mechanisms are different for each of the aforementioned web browsers, they all provide a mechanism for enhancing the web browser and operating system after meeting the browser's trust requirements.

In general terms, trusted code comes in two varieties—signed extensions and unsigned but pre-approved extensions. INTERNET EXPLORER currently uses the first approach. Thus, code which is to become trusted code is first authenticated by an authenticating organization independent of the originator of the code (e.g., VERISIGN or THAWTE) and then “signed” so that an IE web browser will accept the code when received over the internet. In the other variety, used by FIREFOX, the code is deposited at a “safe” website (e.g., the FIREFOX add-ons directory maintained by Mozilla Corporation) and the browser is directed to that site to retrieve the trusted code. Other trust mechanisms now known or developed in the future can, of course, be used in the practice of the invention.

In some cases, it may be desirable to perform certain system modifications to facilitate the receipt of trusted code. For example, when the user's computer is part of a computer network, the network's overall security level can be adjusted to permit the receipt of signed extensions. This can involve adjusting the security level of one or more of: (i) a user computer within the network, (ii) a proxy server within or outside the network, and/or (iii) a firewall within or outside of the network. Although such adjustments can require the involvement of IT professionals, the amount of time required to effectuate the adjustment is minimal compared to the time that would be involved in pre-installing a secure browser on each of the computers served by the network, especially where the security level adjustment is performed above the level of individual computers, as is usually the case.

Whatever trust mechanism is employed, as discussed above, the goal of the various embodiments of the invention is to work within the environment provided by the user's general purpose web browser and to use the available trust mechanism provided by the browser to achieve a secure environment without the need for a pre-installation of software by skilled administrative personnel. In a typical embodiment, the user will take some action to transfer the computer on which he/she is working into a secure mode. As illustrated by the examples presented below, this action can be performed by a user without elevated system access or permissions. Also, the action can be performed in a period of time such as to not cause a significant delay in the administration of the assessment (e.g., less than 20 seconds).

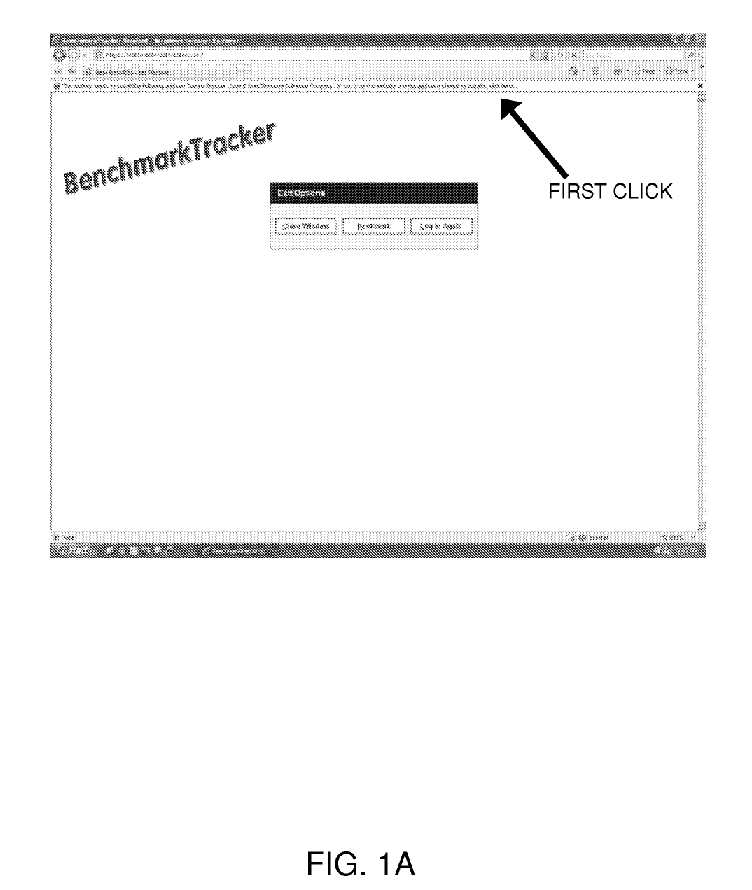

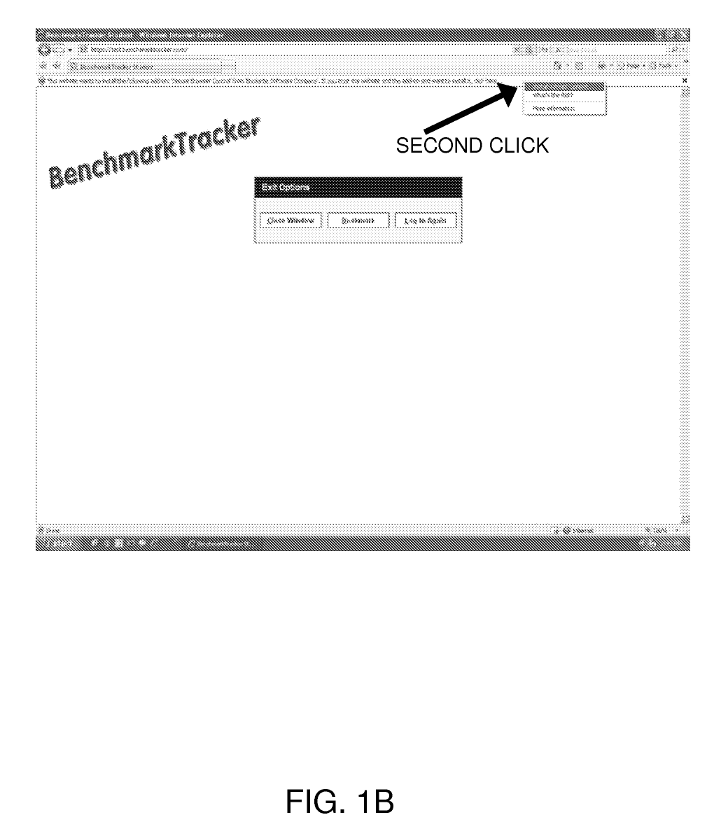

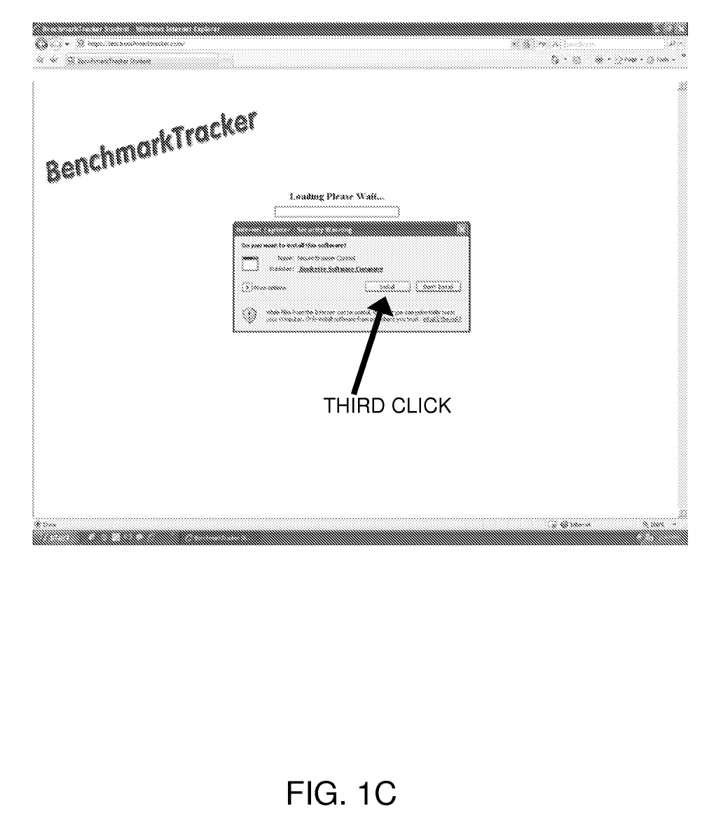

FIGS. 1A-1C show a representative sequence of computer screens that a user would interact with to extend an INTERNET EXPLORER browser with trusted code so that the browser can be used to perform secure on-line testing. FIG. 1A shows the first screen presented to the user from the website's trigger page (see below). This screen has been annotated with the designation “FIRST CLICK.” Clicking on this portion of the screen takes the user to the screen of FIG. 1B, which has been annotated with the designation “SECOND CLICK.” Clicking on this portion of the second screen takes the user to the screen of FIG. 1C, which has been annotated with the designation “THIRD CLICK.” Clicking on this portion of this screen puts the user's computer into secure mode. Similar sequences of screens will be used with other browsers. More or less “clicks” may be needed depending on the specifics of the browser, but the low level of sophistication needed to navigate through the screens will be the same.

As is evident from these screens, the process is simple and straightforward. Many users will be able to navigate through the screens without any help. In some cases, it may be desirable for a test administrator, e.g., a teacher or an aid, to walk the users through the process at least once (e.g., the first time the browser is extended). In either case, IT professionals are plainly not needed to “click” through such a simple set of screens.

The process can made even simpler if the school district sets the security level of the browsers on individual computers to automatically accept trusted code. This can be done at a central location without the need for IT personnel to deal with individual computers. In such a case, the trigger page will automatically transform the user's browser into a secure browser, without the need for any “clicking” or other action by the user. In some cases, a school district may have centrally set its security level so that even trusted code cannot be received by individual computers within the system. In such cases, the school district will typically revise that setting when informed of the benefits in terms of the time burden on IT professionals accruing from allowing trusted code to be loaded, especially since the risks associated with such code are minimal.

The trusted code which is used to extend the user's general purpose web browser can be written in various programming languages, now known or subsequently developed. A currently preferred programming language is C/C++. Preferably, the trusted code comprises less than 10 percent (more preferably, less than 5 percent) of the bytes making up the user's general purpose web browser. Looked at another way, the size of the trusted code preferably comprises less bytes than the bytes of the largest page of the website which the user visits in connection with the on-line testing. Either measure allows runtime extension of an existing browser as opposed to pre-installing. For reference, the current size of INTERNET EXPLORER is approximately 2.3 megabytes and 100-150 kilobytes is currently considered to be a relatively large web page. The size of web pages can be expected to increase in the future as the average bandwidth available to users of the internet increases and thus the size of acceptable extensions can also be expected to increase.

### Website/Server Functions

The overall process is initiated and controlled from a website/server. As is known in the art, a server is a physical entity while a website is a virtual entity served by one or more servers. As used herein, the word “server” includes a single server or a plurality of associated servers. The website can be served on the same server that serves the on-line testing or on a separate server.

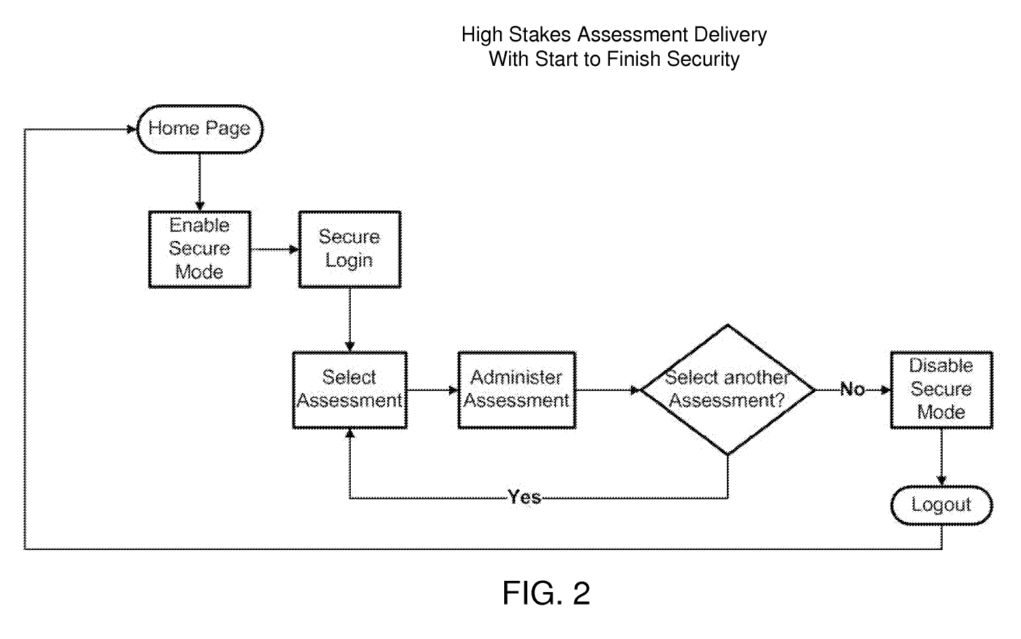

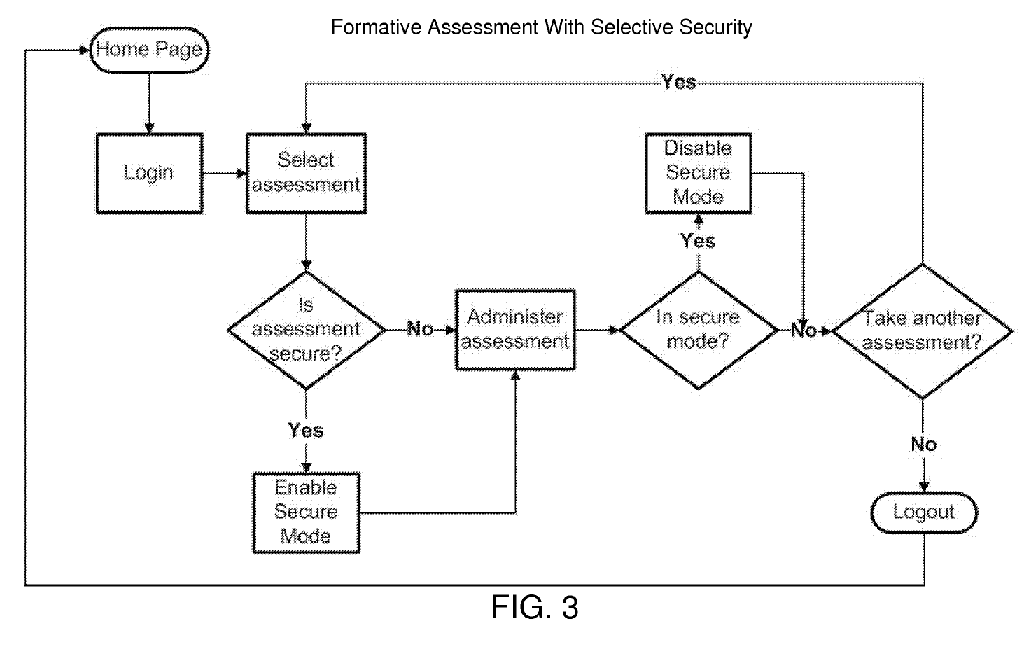

In broad outline, the user uses his/her general purpose web browser to visit the website from which the test is to be administered. FIG. 2 is a flow chart illustrating a suitable sequence of steps that can take place at the website if only secure tests are to be administered, while FIG. 3 shows a set of steps that allows the user to take both secure and un-secure tests, with the test determining whether the user's general purpose web browser or the secure (i.e., extended) browser will be available to the user. The steps of these flow charts relating to secure testing are discussed below. The remaining steps are conventional in on-line testing and can be implemented using a variety of website platforms.

### Transmitting and Activating Trusted Code on the User's Computer

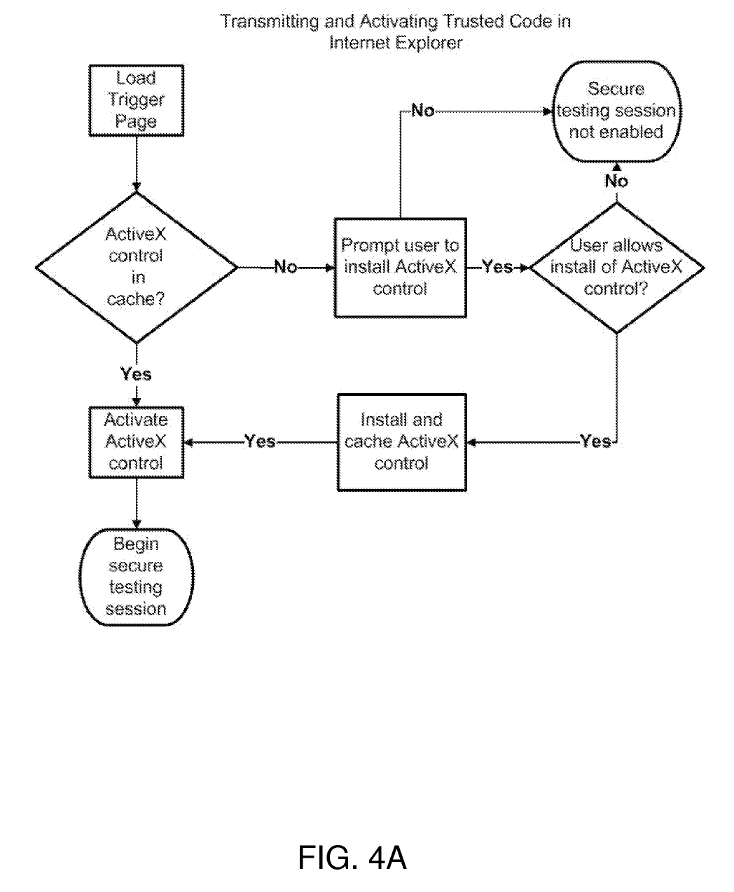

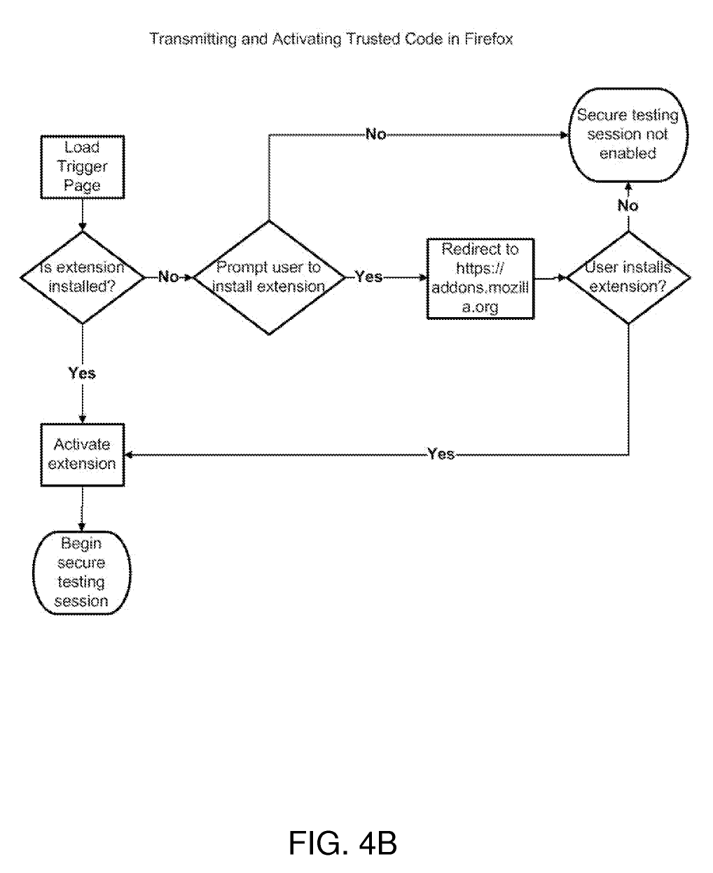

FIGS. 4A and 4B illustrate the steps performed by the website to transmit and activate trusted code on the user's computer. FIG. 4A is for an INTERNET EXPLORER browser, while FIG. 4B is for a FIREFOX browser. As discussed below in Examples 1 and 2, these browsers use different trust mechanisms, thus leading to the different sequences of steps of FIGS. 4A and 4B.

### Restricting the Functionality of the User's Computer

Whether it is an initial extension of the user's general purpose web browser or an enablement of a previously extended browser, the enablement of the trusted code achieves at least one restriction on the functionality of the user's computer. A variety of restrictions can be useful depending on the particulars of the situation.

Examples of such restrictions include, but are not limited to, one or more of: (i) suppressing application and system menu and task bars; (ii) trapping and modifying or disabling control and function keys, e.g., filtering key strokes; (iii) preventing use of a previously-installed calculator; (iv) preventing use of a previously-installed spell checker; (v) preventing use of a previously-installed grammar checker; (vi) preventing searching of files on the user's computer; (vii) preventing searching on an intranet; and/or (viii) preventing searching on the internet.

In general terms, the restrictions involve limiting the functionality of the computer's operating system by making certain operations unavailable to the user. For example, the tool bar, the function keys, and the “start” button are removed from the user's control. Further, some of the restrictions require key stroke capture (also referred to herein as “key stroke filtering”). In general terms, key strokes are filtered by installing an operating system hook which reviews all of the user's key strokes and either allows or denies the operation called for by the keystrokes.

Once the user's browser has been transformed into a secure browser it remains in that state until the test (assessment) is completed. To ensure that the secure browser is active, the web pages which contain the test (assessment) send code to the user's computer which ask the user's computer if it is in secure mode. If the computer does not send back the correct answer, the assessment session is terminated.

### Returning Control to the User's General Purpose Web Browser

Once the functionality of the computer has been restricted, one or more secure tests are administered to the user from the website. As shown in FIGS. 2 and 3 discussed above, once a secure on-line test is completed, the user is given the option of taking another test or returning to the website's home page for further options. In either case, the website ultimately disables the trusted code on the user's computer. If desired, the user can remain connected to the website after the trusted code is disabled. The disabling of the code can take place by simply redirecting the user's browser to a trigger page which causes the extension code to be deactivated.

### EXAMPLES

The following examples illustrate embodiments of the invention based on the popular MICROSOFT WINDOWS and APPLE MAC OSX operating systems. For the MICROSOFT WINDOWS operating system, the embodiments use the popular web browsers, INTERNET EXPLORER (Example 1) and FIREFOX (Example 2). For the APPLE MAC OSX operating system (Example 3), the FIREFOX web browser is used.

Each embodiment leverages the trust mechanism available in the targeted web browser to execute code that implements a desired secure mode for the user's computer. Regardless of the mechanism, the embodiments rely on a trigger page that is controlled by the website delivering the assessment content to signal the activation of secure mode. This signal is specific to each embodiment but can take the form of special markup in the trigger page or through the use of a pre-configured URL.

### Example 1

This example illustrates an embodiment of the invention suitable for use with the WINDOWS operating system and the INTERNET EXPLORER (IE) browser.

The trust mechanism used to enable the secure mode for this embodiment employs an AUTHENTICODE-signed ActiveX control. In broad outline, the control is a static-linked ATL control that does not require external dependencies that are not available on a standard installation of WINDOWS, including runtime DLLs that may or may not exist on the system. The control does not require any special installation requirements above and beyond the download of the ActiveX control. The control is embedded in a web page (the “trigger page”) on the website used to deliver the assessment and activated at the desired time based on the security needs of the assessment.

In particular, the ActiveX control is embedded in the trigger page using an HTML markup of the type shown in Table 1. This markup instructs IE to load the code specified by the codebase attribute and determine the trust level. The code is signed using a trust device called AUTHENTICODE which uses industry standard digital signature technology provided by companies such as VERISIGN and THAWTE to insure the identity of the code's author. If the code is signed, IE will, under its default settings, allow the code to execute at the request of the markup contained in the trigger page.

Upon activation, this embodiment takes the four steps set forth in Table 2. As shown in this table, the first step involves identifying the browser window. Identifying the browser window and obtaining a handle to the browser object for the ActiveX control is one of the primary tasks that must be accomplished. This task can be done in one of two ways depending on the version of the WINDOWS operating system (OS) that is running on the user's computer.

The primary technique is to use the ShellWindows object provided by the SHDOCVW.DLL control library. The ShellWindow interface provides a collection of all the open windows that belong to the shell including the browser window. Iterating through the windows allows the browser window to be identified. A number of techniques can be used to make the identification. Thus, it is possible to identify the browser window by inspecting the contents of the loaded document. However, in practice, simply inspecting the window's title is acceptable since the control and the website can be coordinated as far as the window's title as specified by the <title> tag in the loaded web document. Table 3 illustrates code that can be used for this purpose. The “IsWindowToBeSecured( )” function checks for a predetermined title for the assessment window with the choice of title being selected for uniqueness. The second technique requires more effort and involves using the GetWindow( ), FindWindow( ) or the EnumWindows( ) windows API to locate the HWND for the desired browser window among the list of all top level windows. It should be noted that the ShellWindow approach performs the same function but on an optimized (limited) set of the top level windows guaranteed to contain the browser window.

Once the HWND is located, the AccessibleObjectFromWindow( ) API can be used to obtain a COM interface pointer on the object represented by the window as shown in Table 4. An alternative to the AccessibleObjectFromWindow( ) API is to obtain the pointer to the IDispatch interface by sending a WM_GETOBJECT message to the HWND obtained using FindWindow( ) or one of the other API's mentioned above.

The second step of Table 2 involves forcing the browser window to full screen. Forcing the browser to enter full-screen or “kiosk” mode requires changing the attributes of the browser window identified in the first step. This can be done using the WINDOWS automation interface IWebBrowser2 obtained from an instance of an INTERNET EXPLORER COM object and establishes an event sink for DIID_DWebBrowserEvents2 to receive notifications of web browser window events. This interface in conjunction with standard WINDOWS API calls is used to obtain a handle to the web browser window that needs to be “full screen” and then sends the appropriate messages to enlarge the window (see Table 5).

This embodiment uses a technique for isolating the user to a specific application that involves the addition of the WINDOWS HWND_TOPMOST window flag to force the web browser window into a priority mode where other windows simply cannot be placed in front of the web browser (referred to herein as a “top-of-the-heap procedure”). This flag suppresses a large number of methods whereby a skilled user might be able to get out of secure mode before it is desirable. The code of Table 5 exemplifies this technique. Other steps involved in going into full screen mode involve removing other key application decorations such as the menu bar, tool bar, address bar, and status bar. This is done using the IWebBrowser2 interface. When full screen mode is disabled, the original window styles and position are simply reapplied using code of the type set forth in Table 6.

The third step of Table 2 involves filtering keystrokes. As is well known, application and system shortcuts are implemented with specific key combinations. This embodiment traps keystrokes that are entered by the user and filters out keystrokes that would cause undesirable behavior. This is done using keyboard hooks through the use of the Windows API SetWindowsHookEx( ) using the hook id WH_KEYBOARD for WINDOWS 98 and WH_KEYBOARD_LL for all other versions of WINDOWS. Preferably, all of the keystrokes of Table 7 are filtered once the keyboard hooks are installed, but less or more than those listed can be filter if desired.

The fourth step in Table 2 involves disabling system user interfaces. Certain versions of WINDOWS have user interfaces or other requirements that need to be treated as special cases since they are not addressed using the full-screen window and the keyboard filters. This includes the special handling for WINDOWS 98, a registry setting to disable the Task Manager in systems more recent than WINDOWS 98, and a technique to disable the Start button and the System tray in WINDOWS VISTA.

In WINDOWS 98, a general technique that handles a large number of special cases for disabling activation techniques that open system and 3^{rd} party applications is to “trick” WINDOWS 98 into thinking it is running a screensaver using code of the type shown in Table 8.

For WINDOWS systems beginning with WINDOWS NT and extending through WINDOWS VISTA, the operating system handles Ctl-Alt-Del in a manner that bypasses the keyboard filters described in the third step of Table 2. This can be handled by setting the “DisableTaskMgr” registry value to TRUE under the system policies registry key for the current user (HKEY_CURRENT_USER). This technique works well and only causes conflicts for systems where the network administrator has defined an existing policy disabling the Task Manager which means that the work of disabling this interface has already been addressed by the network security policy. Sample code for disabling this interface is shown in Table 9.

Establishing a secure environment for WINDOWS VISTA is handled using the techniques previously described with two exceptions: (1) the Vista Start button which is used to locate and launch applications installed on the system and (2) the System tray window which displays the systems date and time along with other status icons. Both of these user interfaces are handled specially by the system and are not hidden using the techniques of the second step of Table 2. Therefore, when running on a WINDOWS VISTA system it is necessary to take extra steps to disable these two system user interfaces. Using techniques of the type shown in Table 10 these user interfaces can be disabled by locating the HWND for the specific user interface and hiding the window calls to the Windows ShowWindow( ) API. When secure mode is disabled, these user interfaces can be restored using the same process but with commands to show the windows rather than hide them.

The Task Manager can be handled through the use of several techniques. For example, it can be disabled using a registry flag that is accessible to an ActiveX control running in the web browser. This registry flag disables the Task Manager completely for the current user. Since WINDOWS XP and WINDOWS VISTA bypass keyboard hooks for the key sequence used to display the Task Manager, this extra step is necessary to fully secure the web browser.

### Example 2

This example illustrates an embodiment of the invention suitable for use with open-source FIREFOX browser on WINDOWS and MAC OSX operating systems.

FIREFOX uses a mechanism called “Extensions” to enhance the functionality of the browser. FIREFOX extensions can be installed into the browser by a user but for extensions that do not meet the FIREFOX trust requirements, a strongly worded warning message is displayed that would cause most users to deny the installation of the extension. For the purpose of this embodiment, this is not a desirable situation. For a trusted extension, the installation is extremely quick requiring very little effort from the user and no involvement by skilled IT personnel.

The trust mechanism for the FIREFOX web browser is a community-based feedback model requiring the extension to be submitted to the FIREFOX Add-ons directory at https://addons.mozilla.org/. This directory is hosted and maintained by the Mozilla Corporation and requires that add-ons that are submitted be reviewed by the community and approved by a Mozilla-appointed moderator. Add-ons that have been through this process can be installed in FIREFOX by computer users with normal accounts (i.e., accounts that do not have administrator privileges). More importantly, these installations can be done in as few as 10-15 seconds requiring only a few button clicks before the add-on is active and available to the user.

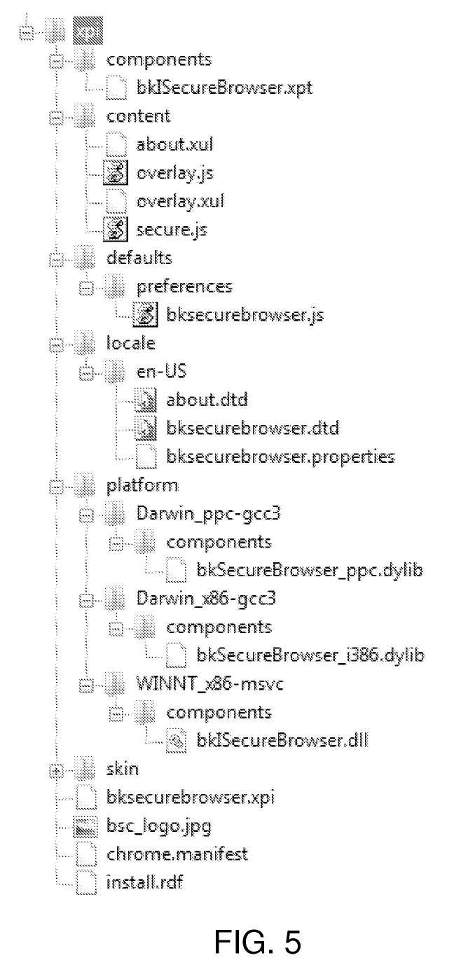

Creating the extension involves following the procedures for creating a typical FIREFOX extension by combining the binary code, javascript code, interface overlays, resources (e.g., images) and manifest files used by FIREFOX to integrate the extension into its interface. The files described above are stored in an XPI file using a directory structure of the type shown in FIG. 5. In general, the techniques to build extensions are well documented at the Mozilla developers site (http://developer.mozilla.org/en/Extensions).

The specific techniques required to build the cross-platform FIREFOX extension include building different versions of a C++ XPCOM (Cross-Platform Component) object for each supported platform, including, for example, WINDOWS (see bkISecureBrowser.dll in FIG. 5), a MAC OSX PowerPC edition (see bkSecureBrowser_ppc.dylib in FIG. 5) and a MAC OSX Intel edition (see bkSecureBrowser_i386.dylib in FIG. 5). Each of these binary objects implements a custom XPCOM interface, named bkISecureBrowser in FIG. 5.

The bkISecureBrowser interface contains the methods bkISecureBrowser::Lock( ) and bkISecureBrowser::Unlock( ), which are the only entry points into the binary component which contains platform specific code. For the WINDOWS operating system, these methods implement the same techniques used by the INTERNET EXPLORER embodiment described in Example 1. For the MAC OSX operating system, other techniques are used for enabling a secure environment as described below in Example 3.

The bkISecureBrowser interface acts as a service that becomes available to the FIREFOX browser but still must be activated. The method used by this embodiment involves creating and registering an address listener as shown in Table 11. The javascript code in Table 11 works on all FIREFOX platforms and uses the platform specific XPCOM binary code described in the previous section implementing the interface shown in Table 12.

### Example 3

This example illustrates an embodiment of the invention suitable for use with the APPLE MAC OSX operating system and the FIREFOX browser. This embodiment uses the techniques described in Example 2 for creating a secure assessment environment in the FIREFOX browser using an XPCOM C++ component as shown in Table 13. This embodiment relies on the Mac OSX API SetSystemUIMode( ) that allows Kiosk mode to be enabled on a MAC operating system by disabling various system user interfaces. The options to SetSystemUIMode( ) allows for disabling the system menu, process switching, activating the force quit user interface, activating the session terminate user interface and the ability to “Hide” the foreground application. The Unlock( ) method shown in Table 13 uses SetSystemUIMode(kUIModeNormal,0) to restore the system back to the normal environment when Kiosk mode is no longer necessary.

### Conclusion

As the foregoing examples illustrate, the invention provides secure on-line testing using existing software available on standard computers and/or computer workstations by taking advantage of the trust models built into general purpose web browsers and/or operating systems to achieve the types of secure environments required by computerized assessments. By eliminating the need for pre-installation of a secure browser, the invention allows secure on-line testing to be implemented without time consuming software installations. IT professionals can be involved in the practice the invention if desired, but importantly, their on-going and extensive participation in achieving a secure environment appropriate to on-line testing is no longer required.

A variety of modifications that do not depart from the scope and spirit of the invention will be evident to persons of ordinary skill in the art from the foregoing disclosure. For example, although the invention has been illustrated in terms of specific restrictions on the functionality of the user's computer, more or less restrictions can be implemented if desired.

Similarly, the specific routines and code sequences referred to the examples are only for purposes of illustration and other routines and computer code can be used in the practice of the invention. For example, as is well known, operating systems, general purpose web browsers, and website/server techniques and hardware continue to evolve. In like manner, trusted code and the mechanisms for creating such code can be expected to evolve over time. Skilled workers will recognize that the present invention as defined by the claims can be practiced both with these technologies as they exist today and as they evolve in the future.

In addition, although the invention has been described in terms of secure on-line testing, it can also be used in connection with providing instruction over the internet. For example, a provider of instructional materials over the internet may want to ensure that users (e.g., students) receiving the materials do not engage in web surfing, messaging, or the like, while they are suppose to be receiving instruction, i.e., the provider may want to make the user's computer more focused on providing the instruction. The same approaches for achieving a secure browser described above for testing can be used during the provision of such instruction. Accordingly, the following claims and the above summary of the various aspects of the invention refer to testing and/or the provision of instruction to a user. For ease of presentation, the remainder of the specification and the abstract are in terms of testing (assessment), it being understood that this is not intended to and should not be interpreted as limiting the scope of the claims.

More generally, the following claims are intended to cover the specific embodiments set forth herein as well as modifications, variations, and equivalents of the foregoing and other types.

TABLE 1
Activation Markup for Trigger Page

<object id=″SBKiosk″ classid=″CLSID:68F8593E-
7FFC-40A3-81F1-680EBEEC59B0″
codebase=″http://www.bookette.com/iesecure/SBKiosk6.dll″>
</object>
<script language=”VBScript”>
SBKiosk.Activate
</script>

TABLE 2

1) Identifying the browser window
2) Force the browser window to full-screen
3) Filter keystrokes
4) Disable system user interfaces

TABLE 3

```
SHDocVw::IWebBrowser2 FindWindowToBeSecured( ) {
  HRESULT hr = CoCreateInstance(_uuidof(SHDocVw::Shell-
  Windows),
        NULL,CLSCTX_INPROC_SERVER, TCHAR
szCaption[MAX_PATH];
  IID_IShellWindows, (LPVOID*)&m_spSHWnds);
  int nCount = (int)m_spSHWnds->GetCount( );
  for (i=0; i < nCount; i++)
  {
    _variant_t va((long)i, VT_I4);
    spDisp = m_spSHWnds->Item(va); // Retrieves the IE object
    SHDocVw::IWebBrowser2Ptr spBrowser(spDisp);
    if (spBrowser != NULL) {
      IWebBrowser2* pIface =
(IWebBrowser2*)(spBrowser.GetInterfacePtr( ));
      HWND hWnd = NULL ;
      HRESULT hr = pIface ->get_HWND((long*)&hWnd);
      GetWindowText(hWnd, szCaption, iMaxLength);
      if( IsWindowToBeSecured(szCaption) ) return spBrowser ;
    }
  }
  return NULL ;
}
```

TABLE 4

HWND hWnd = FindWindow(“IEFrame”, 0 ) ;
AccessibleObjectFromWindow(hWnd,OBJID_CLIENT,IID_IWeb-
Browser2,(void **)&ieobj
);

TABLE 5

```
void ResizeToFullScreen(HWND hWnd)
{
  HDC hDC = GetDC(NULL);
  int iXRes = GetDeviceCaps(hDC, HORZRES);
  int iYRes = GetDeviceCaps(hDC, VERTRES);
  ReleaseDC(NULL, hDC);
  HWND hWndInsertAfter = HWND_TOPMOST;
  DWORD dwStyle = GetWindowLong(hWnd, GWL_STYLE);
  dwStyle &= ~WS_OVERLAPPEDWINDOW;
  dwStyle = SetWindowLong(hWnd, GWL_STYLE, dwStyle);
  SetWindowPos(hWnd, hWndInsertAfter, 0, 0, iXRes, iYRes, 0);
}
```

TABLE 6

```
void ResizeToNormalScreen(HWND hWnd,int oldx,int
oldy,int oldwidth,int oldheight)
{
  HWND hWndInsertAfter = HWND_TOP;
  DWORD dwStyle =GetWindowLong(hWnd, GWL_STYLE);
  dwStyle |= WS_OVERLAPPEDWINDOW;
  dwStyle = SetWindowLong(hWnd, GWL_STYLE, dwStyle);
  SetWindowPos(hWnd, hWndInsertAfter,
  oldx,oldy,oldwidth,oldheight, 0);
}
```

TABLE 7

| Keystroke | Keycode | Alt Key | Ctl Key | Reason For Filtering |
|---|---|---|---|---|
| Windows Key | VK_LWIN or | — | — | Can activate operating |
| | VK_RWIN | | | system interface. |
| Application Key | VK_APPS | — | — | Can activate operating |
| | | | | system interface. |
| Print Screen | VK_SNAPSHOT | — | — | Printing screen is not |
| | | | | desirable in a testing |
| | | | | environment. |
| All Alt Keys | — | On | — | No Alt-key |
| | | | | combinations are desired but |
| | | | | exceptions may be |
| | | | | made for specific cases. |
| All Ctrl Keys | — | — | On | Except Ctl-A, Ctl-P, |
| | | | | Ctl-C, Ctl-V and Ctl-Z to |
| | | | | allow cut, copy and |
| | | | | paste within assessment. |
| Function Key 1 | VK_F1 | | | No function keys are |
| | | | | desired and may be |
| | | | | associated with hot key |
| | | | | applications. |
| Function Key 2 | VK_F2 | | | See Function Key 1. |
| Function Key 3 | VK_F3 | | | See Function Key 1. |
| Function Key 4 | VK_F4 | | | See Function Key 1. |
| Function Key 5 | VK_F5 | | | F5 is used by browsers |
| | | | | for screen refresh and is |
| | | | | undesirable as it may cause |
| | | | | lost responses. |
| Function Key 6 | VK_F6 | | | See Function Key 1. |
| Function Key 7 | VK_F7 | | | See Function Key 1. |
| Function Key 8 | VK_F8 | | | See Function Key 1. |
| Function Key 9 | VK_F9 | | | See Function Key 1. |
| Function Key 10 | VK_F10 | | | See Function Key 1. |
| Function Key 11 | VK_F11 | | | See Function Key 1. |
| Function Key 12 | VK_F12 | | | See Function Key 1. |
| Back Arrow | 0xA6 | | | Must be performed |
| | | | | using assessment interface. |
| Forward Arrow | 0xA7 | | | Must be performed |
| | | | | using assessment |
| | | | | interface. |
| Refresh | 0xA8 | | | Must be performed |
| | | | | using assessment |
| | | | | interface. |
| Search | 0xAA | | | Can activate operating |
| | | | | system interface. |
| Home | 0xAC | | | Can activate operating |
| | | | | system interface. |
| Mail | 0xB4 | | | Can activate operating |
| | | | | system interface. |

TABLE 8
// this is used on windows 98 to trigger kiosk like behavior by
// telling the system that the screensaver is running
// bLock indicates whether the task manager is being locked or unlocked
SystemParametersInfo(SPI_SETSCREENSAVERRUNNING,
true == bLock, &bOldState, 0);

```
TABLE 9
// set registry value for windows nt, xp, 2k, 2k3 or vista
// bLock indicates whether the task manager is being locked or unlocked
DWORD dwValue = (DWORD)(true == bLock);
LRESULT lRes = SetRegistryKeyValue(
  HKEY_CURRENT_USER,
_T(“Software\\Microsoft\\Windows\\CurrentVersion\\Policies\\System”),
  _T(“DisableTaskMgr”),
  (BYTE*)&dwValue,
  sizeof(DWORD),
  REG_DWORD);
LRESULT SetRegistryKeyValue(HKEY key,
            LPCTSTR lpszSubKey,
            LPCTSTR lpszName,
            BYTE* lpbyData,
            int iDataSize,
            DWORD dwDataType)
{
  if (dwDataType == REG_SZ)
    iDataSize = (int)lstrlen((LPCTSTR)lpbyData) + 1;
  else if (dwDataType == 0)
    return E_UNEXPECTED;
  long lResult = E_FAIL;
  HKEY hKey = NULL ;
  if (*lpszSubKey == _T(‘\\’)) lpszSubKey++;
  lResult = ::RegCreateKeyEx(
          key,
          lpszSubKey,
          0,
          NULL,
          REG_OPTION_NON_VOLATILE,
          KEY_ALL_ACCESS,
          NULL,
          &hKey,
          NULL);
  if (lResult != ERROR_SUCCESS) return lResult ;
  lResult = ::RegSetValueEx(
    hKey,
    lpszName,
    0,
    dwDataType,
    lpbyData,
    iDataSize);
  if (lResult != ERROR_SUCCESS)
    lResult = E_FAIL;
  else
    lResult = S_OK;
  if( hKey != NULL ) RegCloseKey(hKey);
  return lResult;
}
```

TABLE 10

```
// vista start button trick
// on vista systems only, this code hides the shell traywindow
// and the Start button since even going to a TOPMOST window
// doesn't work with this controls
HideWindow(_T(“Shell_traywnd”), NULL, bLock);
HideWindow(_T(“Button”), _T(“Start”), bLock);
bool HideWindow(LPCTSTR lpszWndClass, LPCTSTR
lpszWndName, bool bHide)
{
  if ( (NULL == lpszWndClass) || ((NULL != lpszWndClass) &&
(lstrlen(lpszWndClass) > 0)) ) {
    return false;
  }
  HWND hWnd = FindWindow(lpszWndClass, lpszWndName);
  if (NULL == hWnd) {
    return false;
  }
  int nCmdShow = SW_HIDE;
  if (false == bHide) {
    nCmdShow = SW_SHOWNORMAL;
  }
  ShowWindow(hWnd, nCmdShow);
  return true;
}
```

```
TABLE 11
var bkIsBrowserSecure = false ;
var bkDomains = new Array(“localhost”,
                    “bookette.com”,
            “test.benchmarktracker.com”,
            “student.skillwriter.com”) ;
var bkSecureAddressListener = {
  /**
  * Interface to progress listener
  */
  QueryInterface: function(aIID) {
    if (aIID.equals(Components.interfaces.nsIWebProgressListener) ||
        aIID.equals(Components.interfaces.nsISupportsWeakReference) ||
        aIID.equals(Components.interfaces.nsISupports))
      return this;
    throw Components.results.NS_NOINTERFACE;
  },
  /**
  * Fires when the location bar changes or when tabs are switched.
  * This handler should fire in time to toggle cache settings
  */
  onLocationChange: function(aProgress, aRequest, aURI) {
    bkSecureBrowser.checkURL(aURI.spec);
  },
  onStateChange: function( ) { },
  onProgressChange: function( ) { },
  onStatusChange: function( ) { },
  onSecurityChange: function( ) { },
  onLinkIconAvailable: function( ) { }
};
var bkSecureBrowser = {
  // private vars
  _debug: null,
  _console: null,
  _initialized: false,
  _locked: false,
  _bksecure: null,
  _init: function( ) {
    this._console =
Components.classes[‘@mozilla.org/consoleservice;1’].getService(Components.interfaces.-
nsIConsoleService);
  this._bksecure =
Components.classes[‘@bookette.com/securebrowser;1’].createInstance(Components.interfaces.-
bkISecureBrowser);
gBrowser.addProgressListener(bkSecureAddressListener,Components.interfaces.nsIWebProgress.-
NOTIFY_STATE_DOCUMENT);
    this._debug = true ;
    this._locked = false ;
    this.msg(“_init: MARK”);
  },
  init: function( ) {
    if ( !(this._initialized) ) {
      this._init( );
      this._initialized = true;
    }
  },
  uninit: function( ) {
    gBrowser.removeProgressListener(bkSecureAddressListener);
    bkRestoreScreen( ) ;
    this.unlock( ) ;
    this._console = null ;
    this._bksecure = null ;
    this.msg(“uninit”);
  },
  lock: function( ) {
          this._bksecure.Lock( ) ;
          bkShowFullScreen( );
          this._locked = true ;
          this.msg(“checkURL: lock the browser”);
  },
  unlock: function( ) {
          this._bksecure.Unlock( ) ;
          bkRestoreScreen( ) ;
          this._locked = false ;
          this.msg(“checkURL: unlock the browser”);
  },
  checkURL: function(url) {
    var i ;
    for(i=0;i<bkDomains.length;i++) {
      var domain = bkDomains[i] ;
      if( url.indexOf(domain) > 0) {
          this.msg(“checkURL: url matches domain name (“+domain+”)”) ;
          if( url.indexOf(“unlock_browser”) > 0 ) {
            this.unlock( ) ;
          }else if( url.indexOf(“lock_browser”) > 0) {
            this.lock( ) ;
          }
      }
    }
  },
  msg: function(str) {
    if ( this._debug == true ) {
      this._console.logStringMessage(‘bkSecureBrowser::’+str);
    }
  }
};
function bkShowFullScreen( ) {
    //window.fullScreen = true ;
    bkProcessWindows(true) ;
    bkHideNavBar( ) ;
}
function bkRestoreScreen( ) {
    //window.fullScreen = false ;
    bkProcessWindows(false) ;
    bkShowNavBar( ) ;
}
function bkProcessWindows(setFs) {
    var wm = Components.classes[“@mozilla.org/appshell/window-
mediator;1”].getService(Components.interfaces.nsIWindowMediator);
    var enumWin = wm.getEnumerator(null) ;
    var cw=enumWin.getNext( ) ;
    while( cw != null ) {
      cw.fullScreen = setFs ;
      if( setFs ) bkHideNavBar(cw) ;
      else bkShowNavBar(cw) ;
      bkSecureBrowser.msg(‘bkSecureBrowser::’+cw.location.href);
      cw = enumWin.getNext( ) ;
    }
}
function bkSecureCheckListener(e) {
    e.target.setAttribute(“secure”,true) ;
    bkSecureBrowser.msg(‘bkSecureBrowser::bkSecureCheck::Event’) ;
}
document.addEventListener(“bkSecureCheck”,bkSecureCheckListener,false,true) ;
function bkSetEventListener( ) {
    var elem = win.document.getElementById(“bkSecure”) ;
    if( elem == null ) {
      elem = win.document.createElement(“div”) ;
      elem.setAttribute(“id”,“bkSecure”) ;
      win.document.body.appendChild(elem) ;
    }
}
function bkHideNavBar(win) {
    node = win.document.getElementById(‘nav-bar’) ;
      node.setAttribute(‘moz-collapsed’,‘true’) ;
}
function bkShowNavBar(win) {
    node = win.document.getElementById(‘nav-bar’) ;
    node.removeAttribute(‘moz-collapsed’) ;
}
window.addEventListener(“load”,
          function( ) { bkSecureBrowser.init( ); },
          false);
document.addEventListener(“load”,
            function( ) { bkSecureBrowser.init( ) },
            false);
document.addEventListener(“unload”,
            function( ) { bkSecureBrowser.uninit( ) },
            false);
```

TABLE 12

```
#include “nsISupports.idl”
interface nsISimpleEnumerator;
[scriptable, uuid(ea54eee4-9548-4b63-b94d-c519ffc91d09)]
interface bkISecureBrowser : nsISupports
{
    void Lock( );
    void Unlock( );
};
```

TABLE 13

```
#include “SecureBrowser.h”
#include <Carbon/Carbon.h>
#include <ApplicationServices/ApplicationServices.h>
NS_IMPL_ISUPPORTS3(bkSecureBrowser, bkISecureBrowser,
nsIObserver,
nsIContentPolicy);
void LockSystem( ) ;
void UnlockSystem( ) ;
void LockSystem( ) {
  SetSystemUIMode(kUIModeAllHidden,
    kUIOptionDisableAppleMenu|
    kUIOptionDisableProcessSwitch|
    kUIOptionDisableForceQuit|
    kUIOptionDisableSessionTerminate|
    kUIOptionDisableHide) ;
}
void UnlockSystem( ) {
  SetSystemUIMode(kUIModeNormal,0) ;
}
bkSecureBrowser::bkSecureBrowser( )
{
}
bkSecureBrowser::~bkSecureBrowser( )
{
}
NS_IMETHODIMP bkSecureBrowser::Lock( )
{
  LockSystem( ) ;
  return NS_OK ;
}
NS_IMETHODIMP bkSecureBrowser::Unlock( )
{
  UnlockSystem( )
  return NS_OK;
}
```

What is claimed is:

1. A method for administering a test and/or providing instruction over the internet to a user whose installed computer programs comprise a general purpose web browser, said method comprising:
(a) providing a server which is capable of:
(i) transmitting trusted code over the internet to the user's computer; and
(ii) activating said trusted code on said user's computer;
said trusted code extending the user's general purpose web browser so as to restrict the functionality of the user's computer in at least one way;
(b) enabling said trusted code on the user's computer from the server; and
(c) providing the test and/or the instruction to the user on the user's computer from the server while the functionality of the user's computer is restricted in said at least one way;
where the enabling of step (b) comprises either transmitting and activating the trusted code on the user's computer in cases where the trusted code is not pre-cached on the user's computer or activating the trusted code in cases where the trusted code is pre-cached on the user's computer.

2. The method of claim 1 wherein the general purpose web browser has a default mode which as provided by the manufacturer of the browser has a security level that does not ensure that the computer system which runs the browser is in a consistent state from user to user.

3. The method of claim 1 wherein the restriction on the functionality of the user's computer comprises at least one of: (i) suppressing application and system menu and task bars; and (ii) trapping and modifying or disabling control and function keys.

4. The method of claim 1 wherein the restriction on the functionality of the user's computer comprises (i) suppressing application and system menu and task bars, and (ii) trapping and modifying or disabling control and function keys.

5. The method of claim 1 wherein the restriction on the functionality of the user's computer comprises one or more of: (i) preventing use of a previously-installed calculator; (ii) preventing use of a previously-installed spell checker; (iii) preventing use of a previously-installed grammar checker; (iv) preventing searching of files on the user's computer; (v) preventing searching on an intranet; and (vi) preventing searching on the internet.

6. The method of claim 1 wherein the restriction on the functionality of the user's computer comprises forcing the screen into a full screen mode by using a top-of-the-heap procedure.

7. The method of claim 1 wherein the restriction on the functionality of the user's computer comprises identifying a browser window by examining a list of top level windows in a WINDOWS operating system.

8. The method of claim 1 wherein the restriction on the functionality of the user's computer comprises setting a value in a system registry of a WINDOWS operating system in order to prevent the display of an undesired user interface in response to the ctl-alt-del keystroke combination.

9. The method of claim 1 wherein the trusted code is disabled upon completion of a secure test and/or completion of an instructional session.

10. The method of claim 1 wherein the trusted code comprises less than 10 percent of the bytes making up the user's general purpose web browser.

11. The method of claim 1 wherein the method administers a secure test.

12. The method of claim 1 wherein the trusted code is selected from the group consisting of unsigned but pre-approved extensions and signed extensions.

13. The method of claim 1 wherein the trusted code is a signed extension.

14. The method of claim 1 wherein the user's computer is part of a computer network and prior to step (a), the network's overall security level is adjusted to permit the receipt of signed extensions.

15. The method of claim 14 wherein the adjustment of the network's overall security level comprises adjusting the security level of one or more of: (i) a user computer within the network, (ii) a proxy server within or outside the network, and (iii) a firewall within or outside of the network.

16. A computer program embodied in a tangible computer readable medium for performing the method of claim 1.

17. A method for administering a test and/or providing instruction over the internet to a user whose installed computer programs comprise a general purpose web browser, said method comprising:
(a) providing a website which is capable of:
(i) transmitting trusted code over the internet to the user's computer; and
(ii) activating said trusted code on said user's computer,
said trusted code extending the user's general purpose web browser so as to restrict the functionality of the user's computer in at least one way;
(b) enabling said trusted code on the user's computer from the website; and
(c) providing the test and/or the instruction to the user on the user's computer from the website while the functionality of the user's computer is restricted in said at least one way;
where the enabling of step (b) comprises either transmitting and activating the trusted code on the user's computer in cases where the trusted code is not pre-cached on the user's computer or activating the trusted code in cases where the trusted code is pre-cached on the user's computer.

18. The method of claim 17 wherein the general purpose web browser has a default mode which as provided by the manufacturer of the browser has a security level that does not ensure that the computer system which runs the browser is in a consistent state from user to user.

19. The method of claim 17 further comprising disabling the trusted code on the user's computer from the website.

20. The method of claim 19 wherein the user remains at the website after the trusted code is disabled.

21. The method of claim 17 wherein the trusted code comprises less bytes than the bytes of the largest page of the website.

22. A computer system programmed to perform the method of claim 17.

23. A method for taking a test and/or receiving instruction over the internet comprising:
(a) visiting a website using a computer whose installed computer programs comprise a general purpose web browser;
(b) receiving trusted code from the website over the internet, said trusted code extending the general purpose web browser so as to restrict the functionality of the computer in at least one way;
(c) activating the trusted code; and
(d) receiving the test and/or the instruction over the internet from a website while the trusted code is activated.

24. A method for taking a test and/or receiving instruction over the internet using a computer which has (i) a general purpose web browser and (ii) trusted code that extends the general purpose web browser so as to restrict the functionality of the computer in at least one way, said method comprising:
(a) visiting a website that activates the trusted code; and
(b) receiving the test and/or the instruction over the internet from a website while the trusted code is activated.

25. A system comprising:
(a) a processor;
(b) an internet connection coupled to the processor; and
(c) a memory unit coupled to the processor, said memory unit storing a computer program for transforming a user's general purpose web browser into a secure browser, said computer program including programming instructions for performing the following steps:
(i) transmitting trusted code through the internet connection to a user's computer; and
(ii) activating said trusted code on the user's computer;
wherein the trusted code extends a general purpose web browser on the user's computer so as to restrict the functionality of the user's computer in at least one way.
